(19) United States
(12) Patent Application Publication
(10) Pub. No.: US 2025/0287098 A1
(43) Pub. Date: Sep. 11, 2025

(54) DETECTION DEVICE, CAMERA SYSTEM, DETECTION METHOD, AND STORAGE MEDIUM STORING DETECTION PROGRAM

(71) Applicant: Mitsubishi Electric Corporation, Tokyo (JP)

(72) Inventors: Yusuke OTA, Tokyo (JP); Keiji UEMURA, Tokyo (JP); Masahide KOIKE, Tokyo (JP)

(73) Assignee: Mitsubishi Electric Corporation, Tokyo (JP)

(21) Appl. No.: 18/862,572

(22) PCT Filed: May 16, 2022
(86) PCT No.: PCT/JP2022/020398

§ 371 Date: Nov. 4, 2024

(51) Int. Cl. H04N 23/667; G08B 13/196; H04N 23/60; H04N 23/617

(52) U.S. Cl. CPC H04N 23/667; G08B 13/19613; H04N 23/617; H04N 23/64

(57) ABSTRACT

A detection device includes a detection processing unit to execute a detection process of using a learned model selected from a plurality of learned models, using an image as an input to the selected learned model, and obtaining a detection result, as a result of detecting an object in the image, as an output from the selected learned model and a model control unit to execute a determination process of having the detection process executed in regard to each of the plurality of learned models, calculating accuracy of the detection result in regard to each of the plurality of learned models, and determining a recommended learned model out of the plurality of learned models based on the accuracy. The detection process after the determination process is executed by using the recommended learned model.

### TECHNICAL FIELD

The present disclosure relates to a detection device, a camera system, a detection method and a detection program.

### BACKGROUND ART

In recent years, it is becoming possible to detect an object in an image captured by a camera by using an AI (Artificial Intelligence) model as a learned model. However, in cases of a system performing the image capturing for a long time such as a monitoring camera system, accuracy of the object detection fluctuates due to environmental variations such as the passage of time and the change of seasons. Thus, there has been proposed a detection device that selects and uses an appropriate AI model out of a plurality of AI models based on the result of detecting surrounding environment with a sensor (see Patent Reference 1, for example).

### PRIOR ART REFERENCE

### Patent Reference

Patent Reference 1: Japanese Patent Application Publication No. 2020-170319.

### SUMMARY OF THE INVENTION

### Problem to be Solved by the Invention

However, the conventional detection device described above selects an AI model based on the surrounding environment, and thus there are cases where an AI model with high detection accuracy is not selected from the plurality of AI models.

An object of the present disclosure is to provide a detection device, a camera system, a detection method and a detection program that make it possible to determine and use a learned model with high detection accuracy out of a plurality of learned models for detecting an object in an image.

A detection device in the present disclosure includes a detection processing unit that executes a detection process of using a learned model selected from a plurality of learned models, using an image as an input to the selected learned model, and obtaining a detection result, as a result of detecting an object in the image, as an output from the selected learned model and a model control unit that executes a determination process of having the detection process executed in regard to each of the plurality of learned models, calculating accuracy of the detection result in regard to each of the plurality of learned models, and determining a recommended learned model out of the plurality of learned models based on the accuracy. The detection process after the determination process is executed by using the recommended learned model.

A detection method in the present disclosure is a method to be executed by a detection device. The detection method includes a step of executing a detection process of using a learned model selected from a plurality of learned models, using an image as an input to the selected learned model, and obtaining a detection result, as a result of detecting an object in the image, as an output from the selected learned model, a step of executing a determination process of having the detection process executed in regard to each of the plurality of learned models, calculating accuracy of the detection result in regard to each of the plurality of learned models, and determining a recommended learned model out of the plurality of learned models based on the accuracy, and a step of executing the detection process after the determination process by using the recommended learned model.

### Effect of the Invention

According to the present disclosure, it is possible to determine and use a learned model with high detection accuracy out of a plurality of learned models for detecting an object in an image.

### BRIEF DESCRIPTION OF THE DRAWINGS

FIG. 1 is a block diagram schematically showing the configuration of a detection device and a camera system according to a first embodiment.

FIG. 2 is a diagram showing an example of the hardware configuration of the detection device and the camera system according to the first embodiment.

FIG. 3 is an explanatory diagram showing the operation of a person detection AI model used by a detection processing unit of the detection device according to the first embodiment.

FIG. 4 is an explanatory diagram showing the operation of a face detection AI model used by the detection processing unit of the detection device according to the first embodiment.

FIG. 5 is an explanatory diagram showing a state in which a plurality of AI models are deployed in a working memory of the detection device according to the first embodiment.

FIG. 6 is a flowchart showing a process for determining a recommended AI model to be used by the detection processing unit of the detection device according to the first embodiment.

FIG. 7 is a flowchart showing a process after the determination of the recommended AI model to be used by the detection processing unit of the detection device according to the first embodiment.

FIG. 8 is an explanatory diagram showing a process of switching the AI model to be used by the detection processing unit of the detection device according to the first embodiment.

FIG. 9 is a block diagram schematically showing the configuration of a detection device and a camera system according to a second embodiment.

FIG. 10 is an explanatory diagram showing the operation when AI models are deployed in the working memory of the detection device according to the second embodiment.

FIG. 11 is a flowchart showing a process for determining the recommended AI model to be used by the detection processing unit of the detection device according to the second embodiment.

FIG. 12 is a block diagram schematically showing the configuration of a detection device and a camera system according to a third embodiment.

FIG. 13 is a diagram showing an example of a process for determining the recommended AI model to be used by the detection processing unit of the detection device according to the third embodiment.

FIG. 14 is a diagram showing another example of the process for determining the recommended AI model to be used by the detection processing unit of the detection device according to the third embodiment.

### MODE FOR CARRYING OUT THE INVENTION

A detection device, a camera system including the detection device, a detection method, and a detection program according to each embodiment will be described below with reference to the drawings. The following embodiments are just examples and it is possible to appropriately combine embodiments and appropriately modify each embodiment.

### First Embodiment

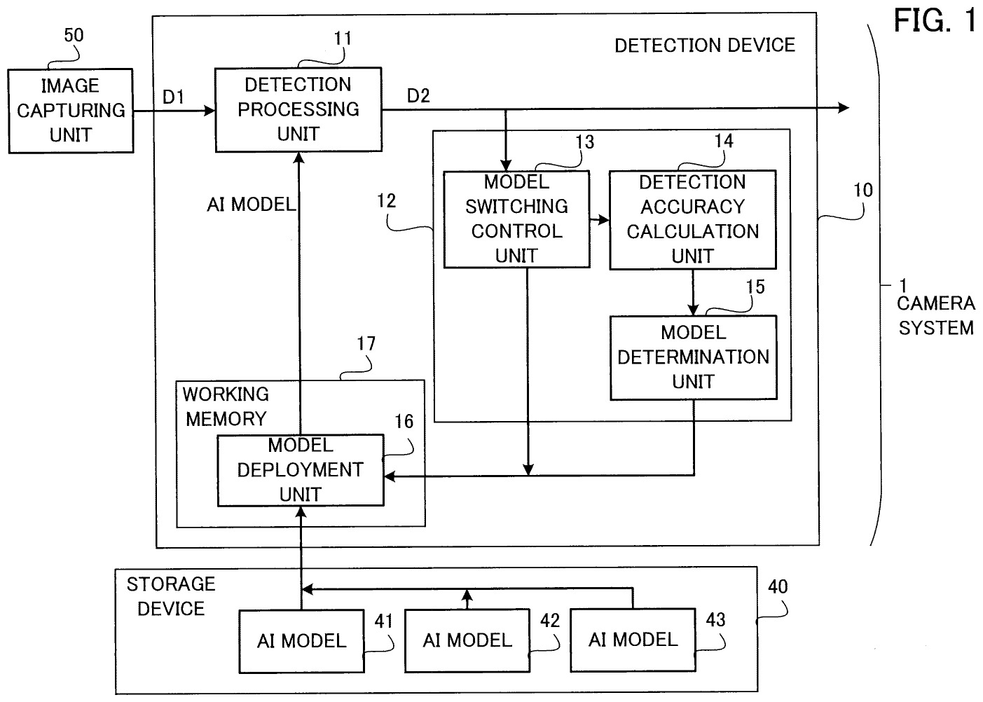

FIG. 1 is a block diagram schematically showing the configuration of a detection device 10 and a camera system 1 according to a first embodiment. The detection device 10 is a device capable of executing a detection method according to the first embodiment. As shown in FIG. 1, the camera system 1 includes the detection device 10 and an image capturing unit (i.e., camera) 50 as an image input unit that captures an image. The detection device 10 includes a detection processing unit 11, a model control unit 12, a model deployment unit 16, and a working memory 17 as an internal memory. The model control unit 12 includes a model switching control unit 13, a detection accuracy calculation unit 14 and a model determination unit 15.

The detection device 10 is connected to a storage device 40 including a storage medium as an external memory, via a network, for example. The storage device 40 can also be a part of the detection device 10. Further, the storage device 40 can include a plurality of storage media arranged at a plurality of different places. The storage device 40 has stored a plurality of AI models 41, 42 and 43 as a plurality of learned models. It is permissible if the number of the stored AI models is greater than or equal to 2.

The image capturing unit 50 is, for example, a monitoring camera installed indoors or outdoors. This monitoring camera is a visible light camera or an infrared camera, for example. The image capturing unit 50 captures an image suitable for the purpose of the camera system 1. The image can be, for example, an image capturing the vicinity of an entrance of a building, an image capturing a road, an image capturing the inside of a building, or the like.

The detection processing unit 11 executes a detection process of using an AI model selected from the plurality of usable AI models 41, 42 and 43, using an image D1 as an input to the selected AI model, and obtaining a detection result D2, as the result of detecting an object in the image D1, as an output from the selected AI model. The model control unit 12 executes a determination process of making the detection processing unit 11 execute the detection process in regard to each of the plurality of AI models 41, 42 and 43, calculating the accuracy of the detection result in regard to each of the plurality of AI models 41, 42 and 43, and determining a recommended AI model out of the plurality of AI models 41, 42 and 43 based on the accuracy. The detection process by the detection processing unit 11 after the determination process is executed by using the recommended AI model. The plurality of usable AI models are not limited to those stored in the storage device 40. The plurality of usable AI models can also be, for example, those stored in a plurality of different storage devices or those stored in a storage device of a network server capable of communication.

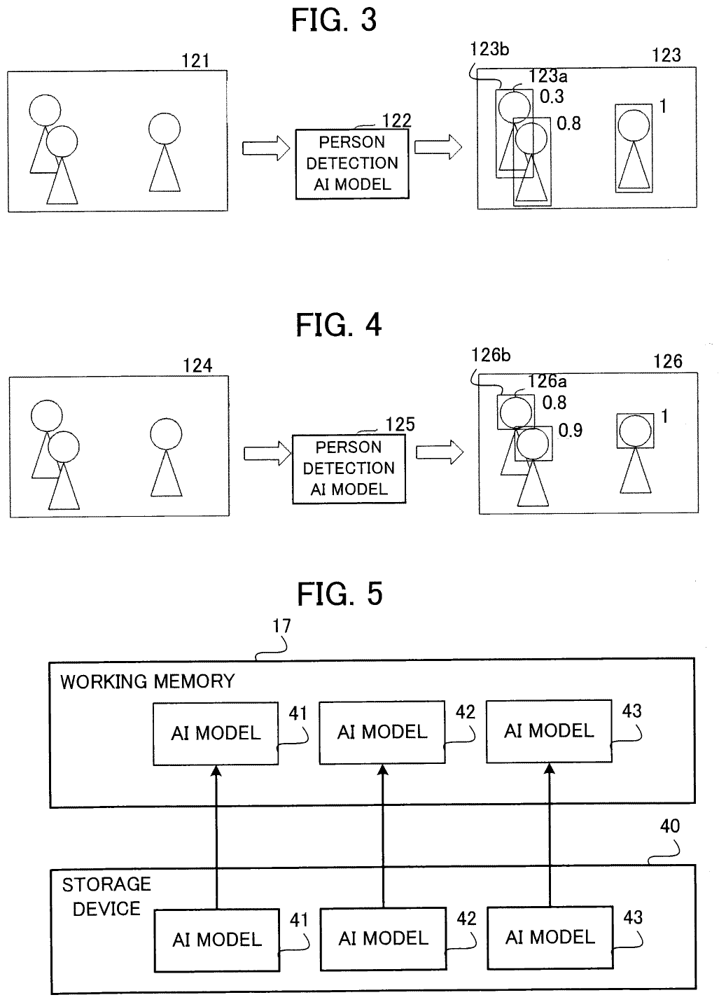

In the example of FIG. 1, the detection processing unit 11 selects the recommended AI model, as an AI model switched by the model switching control unit 13 or an AI model determined by the model determination unit 15, out of one or more AI models (e. g., the AI models 41, 42 and 43) deployed in the working memory 17, executes the detection process of detecting an object in the image D1 by using the selected AI model, and outputs the detection result D2. The object can be a person or an animal. The detection result D2 includes, for example, coordinates and detection accuracy of each of a certain number of detection frames (e.g., detection frame 123b in FIG. 3 which will be explained later) equal to the number of detected objects. When two or more objects have been detected, the detection processing unit 11 obtains an average value Av (an example of a statistical value) of the detection accuracies outputted for the number of detected objects as the detection accuracy of a frame. The detection accuracy is outputted as a numerical value from “0” to “1”, for example. It is also possible for the detection processing unit 11 to handle a value other than the average value as the detection accuracy or use a different statistical value obtained by statistical processing. The following description will be given by using the average value Av as the detection accuracy.

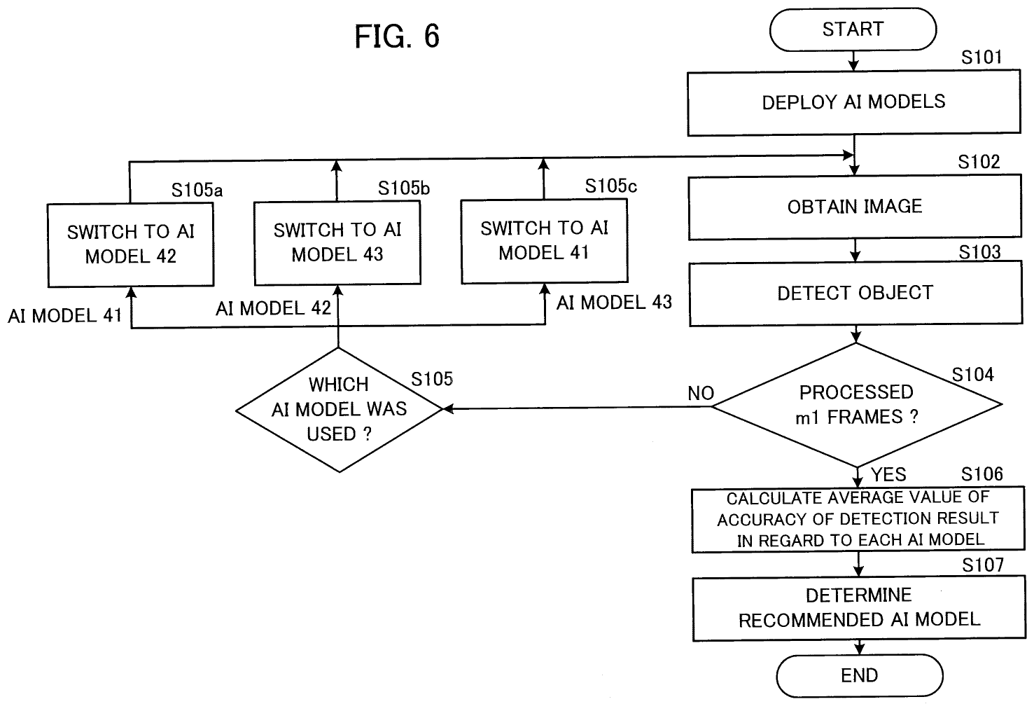

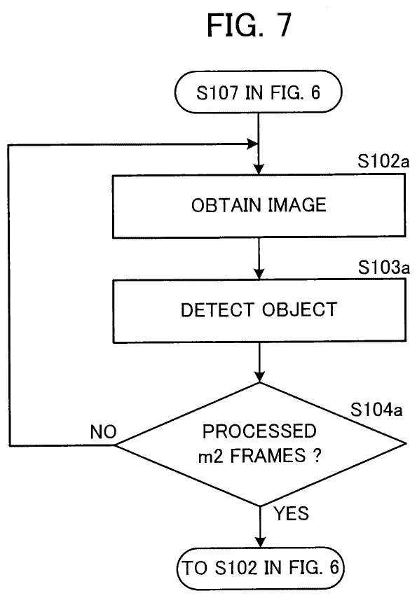

The model switching control unit 13 checks the number of frames in the image that have undergone the detection process by the detection processing unit 11 and executes switching control of the AI model to be used by the detection processing unit 11. Details of the switching control will be described later with reference to FIG. 6 and FIG. 7.

The detection accuracy calculation unit 14 calculates the average value Av (e.g., average value Av1, Av2, Av3 corresponding to the AI model 41, 42, 43) of the detection accuracy in a predetermined number of frames in the image in regard to each AI model based on the detection result outputted from each AI model when the detection processing unit 11 executed the object detection process by using each AI model.

The model determination unit 15 determines which AI model out of the plurality of AI models 41, 42 and 43 loaded in the working memory 17 should be selected as the recommended AI model to be used by the detection processing unit 11 by using the detection accuracy average value Av in regard to each AI model obtained by the detection accuracy calculation unit 14. Out of the plurality of AI models 41, 42 and 43, the recommended AI model is an AI model whose detection accuracy average value Av is the greatest, for example.

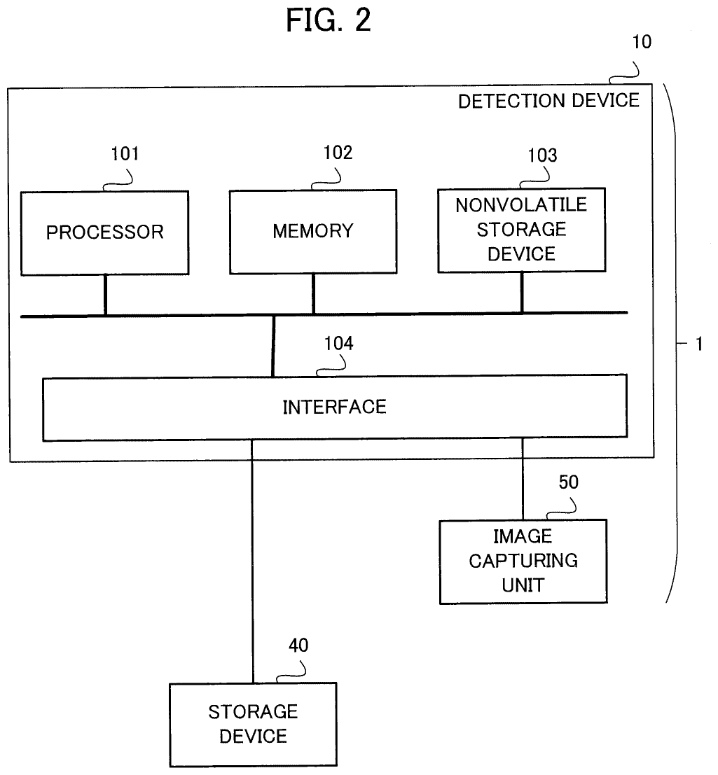

FIG. 2 is a diagram showing an example of the hardware configuration of the detection device 10 and the camera system 1 including the detection device 10. The detection device 10 is a computer as an information processing device, for example. The detection device 10 includes a processor 101, a memory 102, a nonvolatile storage device 103 and an interface 104. The processor 101 is a CPU (Central Processing Unit) or the like. The memory 102 is a volatile semiconductor memory such as a RAM (Random Access Memory), for example. The nonvolatile storage device 103 is a hard disk drive (HDD), a solid state drive (SSD) or the like. The interface 104 is provided in order to execute communication with other devices. The image capturing unit 50 and the external storage device 40 may be connected to the interface 104.

Functions of the detection device 10 are implemented by processing circuitry. The processing circuitry can be either dedicated hardware or the processor 101 executing a program stored in the memory 102. The processor 101 can be any one of a processing device, an arithmetic device, a microprocessor, a microcomputer and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, a detection method or a detection program according to the first embodiment is implemented by software, firmware, or a combination of software and firmware. The software and the firmware are described as programs and stored in the memory 102. The detection program is installed in the detection device 10 by downloading via a network or installation from an information record medium such as an optical disc. The processor 101 is capable of implementing the functions of the units shown in FIG. 1 by reading out and executing the detection program stored in the memory 102. It is also possible to implement part of the detection device 10 by dedicated hardware and other part of the detection device 10 by software or firmware. As above, the processing circuitry is capable of implementing the functions of the functional blocks shown in FIG. 1 by hardware, software, firmware or a combination of some of these means.

FIG. 3 is an explanatory diagram showing the operation of a person detection AI model 122 as an example of the AI model used by the detection processing unit 11 of the detection device 10 according to the first embodiment. FIG. 3 indicates an output (i.e., detection result) 123 when an image is used as an input 121 to the person detection AI model 122. As shown in the output 123, the person detection AI model 122 outputs detection frames 123b and detection accuracies “0.3”, “0.8” and “1” of people 123a. In this frame, three people are detected, and the detection accuracy of each person is “0.3”, “0.8” and “1”. Therefore, the detection accuracy by the person detection AI model 122 in this frame is calculated as {(0.3+0.8+1)/3} and is “0.7”.

FIG. 4 is an explanatory diagram showing the operation of a face detection AI model 125 as an example of the AI model used by the detection processing unit 11 of the detection device 10 according to the first embodiment. FIG. 4 indicates an output (i.e., detection result) 126 when an image is used as an input 124 to the face detection AI model 125. As shown in the output 126, the face detection AI model 125 outputs detection frames 126b and detection accuracies “0.8”, “0.9” and “1” of faces 126a. In this frame, three faces are detected, and the detection accuracy of each face is “0.8”, “0.9” and “1”. Therefore, the detection accuracy by the face detection AI model 125 in this frame is calculated as {(0.8+0.9+1)/3} and is “0.9”.

FIG. 5 is an explanatory diagram showing a state when a plurality of AI models are deployed in the working memory 17 of the detection device 10 according to the first embodiment. The storage device 40 stores the plurality of AI models 41, 42 and 43. The storage medium of the storage device 40 is a nonvolatile memory, for example. The AI models 41, 42 and 43 are AI models generated by use of deep learning, for example. The AI models 41, 42 and 43 are AI models published on websites or the like, for example. The AI models 41, 42 and 43 can be AI models generated by a learning device that collects learning data (e.g., image data) and executes learning by use of the collected learning data.

There is no restriction on the image data used for the learning; image data published on websites may also be used, for example. The image data used for the learning can also be image data captured by a digital camera or image data captured by a monitoring camera in which the detection device 10 is scheduled to be installed. Further, there is no limitation on the number of AI models stored in the storage device 40 as long as the AI models can be retained within the capacity of the storage device 40.

Each AI model 41, 42, 43 is an AI model capable of executing the object detection, such as a person detection AI model, a face detection AI model, an object detection AI model with high detection accuracy of object detection in an image in a daytime situation, an object detection model with high detection accuracy of object detection in an image in an evening situation, an object detection AI model with high detection accuracy of object detection in an image in a nighttime situation, or the like, for example.

The person detection AI model is a model for detecting whether or not there is a person in a captured image, and is capable of detecting a person with high detection accuracy not only when the person is facing the direction of the camera but also when the person is facing sideways or backward with respect to the camera direction since the person detection AI model is a model generated by use of image data captured from a variety of angles or heights as the learning data. However, the detection accuracy drops when even a part of the person is hidden since the person detection is performed by viewing the entirety of the person. In the output 123 in FIG. 3, the detection accuracy drops since a person 123a captured in a left rear part is partially hidden by a person in front.

The face detection AI model is a model for detecting whether or not there is a face in a captured image, and is capable of detecting a face even when the neck and body parts below are hidden since image data captured from a variety of angles or heights within a range where the face is visible are used as the learning data, whereas the detection accuracy drops when the face is facing sideways or backward with respect to the camera direction. Even though a face 126a captured in a left rear part of the output 126 in FIG. 4 is partially hidden by a person in front, the detection accuracy is high since the face part is captured.

The object detection AI model with high detection accuracy of object detection in an image in a daytime situation is a model generated based on image data captured in the daytime, the object detection AI model with high detection accuracy of object detection in an image in an evening situation is a model generated based on image data captured in the evening, and the object detection AI model with high detection accuracy of object detection in an image in a nighttime situation is a model generated based on image data captured in the nighttime.

The model deployment unit 16 deploys the plurality of AI models 41, 42 and 43 stored in the storage device 40 in the working memory 17 as shown in FIG. 5.

FIG. 6 is a flowchart showing a process for determining the recommended AI model to be used by the detection processing unit 11 of the detection device 10 according to the first embodiment. By using FIG. 6, the recommended AI model with high detection accuracy is determined out of the plurality of AI models 41, 42 and 43 in the working memory 17.

The model deployment unit 16 deploys the plurality of AI models 41, 42 and 43 stored in the storage device 40 in the working memory 17 (step S101). Further, the image capturing unit 50 captures an image and thereby obtains the image (i.e., image data of a plurality of frames) (step S102).

The detection processing unit 11 executes the detection process by using the recommended AI model as an AI model switched by the model switching control unit 13 or an AI model determined by the model determination unit 15. In the first frame after the startup of the detection device 10, the AI model 41 is used, for example. While the AI model 41 is assumed here to be used for the object detection in the first frame, the AI model used first can also be a different AI model (step S103).

The model switching control unit 13 judges whether or not the detection process for a predetermined frame number (i.e., set number) m1 of frames has been finished (step S104).

When the model switching control unit 13 in the step S104 judges that the detection process for the frame number m1 of frames has not been finished, the model switching control unit 13 checks which AI model is the AI model used by the detection processing unit 11 (step S105).

The model switching control unit 13 switches the AI model to be used by the detection processing unit 11 to an AI model to be used for the object detection in the next frame. If the AI model 41 was used for the object detection in the present frame, the AI model is switched to the AI model 42 as the AI model to be used for the object detection in the next frame (step S105a). If the AI model 42 was used for the object detection in the present frame, the AI model is switched to the AI model 43 as the AI model to be used for the object detection in the next frame (step S105b). If the AI model 43 was used for the object detection in the present frame, the AI model is switched to the AI model 41 as the AI model to be used for the object detection in the next frame (step S105c).

When the model switching control unit 13 in the step S104 judges that the detection process for the frame number m1 of frames has been finished, the detection accuracy calculation unit 14 calculates the average value Av of the detection accuracy in regard to each AI model from the detection accuracies regarding the frames outputted from each AI model 41, 42, 43 and the number of the processed frames (step S106).

The model determination unit 15 determines an AI model whose detection accuracy average value Av is high (e.g., AI model whose average value Av is the highest) as the recommended AI model (step S107).

FIG. 7 is a flowchart showing a process after the determination of the recommended AI model to be used by the detection processing unit 11 of the detection device 10 according to the first embodiment. FIG. 7 shows a process after the model determination unit 15 has determined an AI model with high detection accuracy as the recommended AI model.

First, the image capturing unit 50 captures an image (step S102a). The detection processing unit 11 executes the detection process by using the recommended AI model determined by the model determination unit 15 in the step S107 in FIG. 6 (step S103a).

The model switching control unit 13 judges whether or not the detection process for a predetermined frame number (i.e., set number) m2 of frames has been finished (step S104a).

When the model switching control unit 13 in the step S104a judges that the detection process for the frame number m2 of frames has not been finished, the processing of the steps S102a and S103a is repeated. When the model switching control unit 13 in the step S104a judges that the detection process for the frame number m2 of frames has been finished, the process returns to the step S102 in FIG. 6.

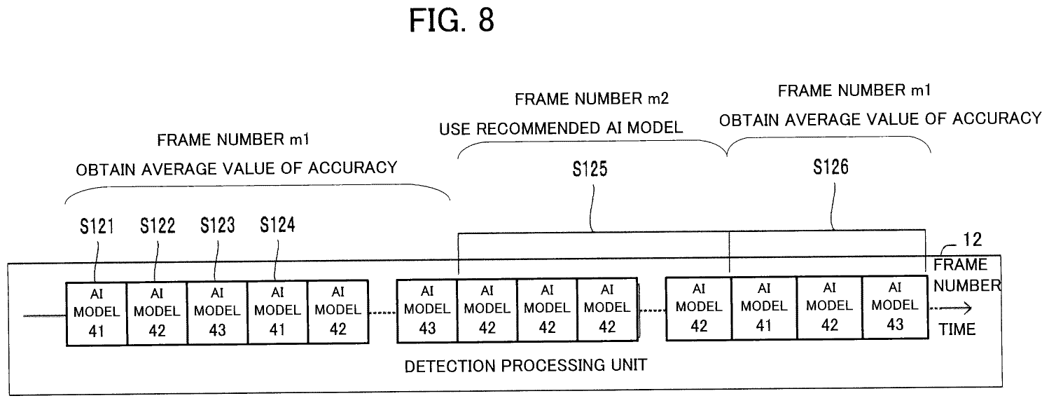

FIG. 8 is an explanatory diagram showing a process of switching the AI models to be used by the detection processing unit 11 of the detection device 10 according to the first embodiment. FIG. 8 indicates an example of switching order of the AI models to be used by the detection processing unit 11. In the example of FIG. 8, three AI models 41, 42 and 43 have been deployed in the working memory 17. First, the detection processing unit 11 executes the object detection process by using the AI model 41 (step S121).

After the processing of the steps S104, S105 and S105a in FIG. 6 is executed, the detection processing unit 11 executes the object detection process by using the AI model 42 (step S122).

After the processing of the steps S104, S105 and S105b in FIG. 6 is executed, the detection processing unit 11 executes the object detection process by using the AI model 43 (step S123).

After the processing of the steps S104, S105 and S105c in FIG. 6 is executed, the detection processing unit 11 executes the object detection process by using the AI model 41 (step S124).

As shown in FIG. 8, in order to obtain the average value of the accuracy of the object detection, the detection device 10 switches the AI models (i.e., the AI models 41, 42, 43 deployed in the working memory 17) for a number of times equal to the frame number m1. When the model switching control unit 13 judges that the AI model has been switched for a number of times equal to the frame number m1, the model determination unit 15 determines the recommended AI model to be used by the detection processing unit 11 in the next frame and later based on the average value Av of the accuracy of the detection result. The description here will be given assuming that the recommended AI model determined by the model determination unit 15 is the AI model 42. Thereafter, the detection processing unit 11 executes the object detection process for the frame number m2 of frames by using the AI model 42 as the determined recommended AI model (step S125).

When the model switching control unit 13 judges that the detection process for the frame number m2 of frames has been finished, the detection device 10 repeats the processing of the steps S102, S103, S104, S105 and S105a, the processing of the steps S102, S103, S104, S105 and S105b, and the processing of the steps S102, S103, S104, S105 and S105c (step S126). The judgment by the model determination unit 15 is made after the total number of frames processed by the three AI models 41, 42 and 43 has reached the predetermined frame number m1. However, the determination of the recommended AI model by the model determination unit 15 may also be made after each of the AI models 41, 42 and 43 has completed the detection process for a predetermined frame number (e.g., m3) of frames.

The camera system 1 according to the first embodiment can be used in the following situations.

First, a description will be given of an example in which two AI models, a person detection AI model and a face detection AI model, are used in person tracking in station precincts with a lot of foot traffic, a commercial facility, or the like. For the person tracking, it becomes necessary to first detect a person and thereafter acquire a feature value of the person. If the accuracy of the detection process is low, a feature specific to the person cannot be acquired, and thus the accuracy of the person tracking drops.

In the detection device 10, the detection accuracy can be maintained high by switching between the person detection AI model and the face detection AI model depending on the accuracy of the detection process. Here, the AI model 41 is assumed to be the person detection AI model and the AI model 42 is assumed to be the face detection AI model. When the person is facing sideways or backward, or when the person is situated at a position far from the image capturing unit as a camera where the area of the face becomes small, it can be anticipated that the detection accuracy of the output of the AI model 41 becomes higher. In contrast, when the overlap between a person and a person increases, it can be anticipated that the detection accuracy of the output of the AI model 42 becomes higher. Thus, in these environments, the AI model 41 and the AI model 42 are used by the detection processing unit 11. In cases where there are few people and the people are facing forward, it is unclear which AI model is used; however, one of the two AI models having higher detection accuracy is used by the detection processing unit 11.

As above, by the switching of the AI model to suit the environment, the detection accuracy of the person detection and the face detection can be increased.

Next, a description will be given of an example in which three AI models: an object detection AI model with high accuracy of object detection in an image in a daytime situation, an object detection AI model with high accuracy of object detection in an image in an evening situation, and an object detection AI model with high accuracy of object detection in an image in a nighttime situation, are used in invasion detection in a place rarely dropped in. For the camera invasion detection, it is necessary to execute the object detection first, and thus low detection accuracy of the object detection leads to a drop in the detection accuracy of the invasion detection.

In the detection device 10, the detection accuracy can be made high by switching among these three AI models to suit the environment. The AI model 41 is assumed to be the object detection AI model with high detection accuracy of object detection in an image in a daytime situation, the AI model 42 is assumed to be the object detection AI model with high detection accuracy of object detection in an image in an evening situation, and the AI model 43 is assumed to be the object detection with high detection accuracy of object detection in an image in a nighttime situation. In a time slot in the daytime, it can be anticipated that the detection accuracy in the case of using the AI model 41 is the highest. In a time slot in the evening, it can be anticipated that the detection accuracy in the case of using the AI model 42 is the highest. In a time slot in the nighttime, it can be anticipated that the detection accuracy in the case of using the AI model 43 is the highest. Thus, in these environments, the AI model 41, the AI model 42 and the AI model 43 are respectively used by the detection processing unit 11. In a time slot between the evening and the nighttime or a time slot between the nighttime and the morning, it is unclear which AI model is used; however, one of the three AI models having the highest detection accuracy is used by the detection processing unit 11.

When only one AI model is used, object detection with high accuracy is impossible in the nighttime even if object detection with high accuracy is possible in the daytime. In the detection device 10, AI models specific to each time slot are prepared and an AI model with the highest detection accuracy among the AI models is used by the detection processing unit 11, and thus the object detection can be executed with high detection accuracy in any time slot.

As described above, according to the first embodiment, the average value Av of the object detection accuracy is calculated for each of the plurality of AI models deployed in the working memory 17, and an AI model with a great average value Av (recommended AI model) is used for the object detection in the next frame and later, by which the object detection process can be executed by using an AI model maximizing the detection accuracy in the environment among the plurality of AI models.

In the first embodiment, it is also possible to switch the AI model to be used depending on whether illumination in a room is on or off. Further, in the first embodiment, it is also possible to switch the AI model to be used depending on whether light from the sun is coming in or not. In the first embodiment, it is also possible to switch the AI model to be used depending on whether the direction of light from the sun is front lighting or backlighting.

Further, when the same AI model operates in the detection processing unit 11 for a long time, the detection accuracy by use of the AI model can drop due to a change in the environment. Therefore, the AI model determined by the model determination unit 15 is switched after processing an arbitrarily designated number of frames so that an AI model with high detection accuracy in the environment is used. Consequently, high detection accuracy can be maintained even in a camera system executing the image capturing for a long time such as a monitoring camera.

Furthermore, while the detection processing unit 11 executes the detection process and outputs the detection result in regard to each frame in an image, the frames as the objects of the detection process do not need to be strictly continuous; it is permissible even if some of the frames are skipped or frames are periodically thinned out, for example.

### Second Embodiment

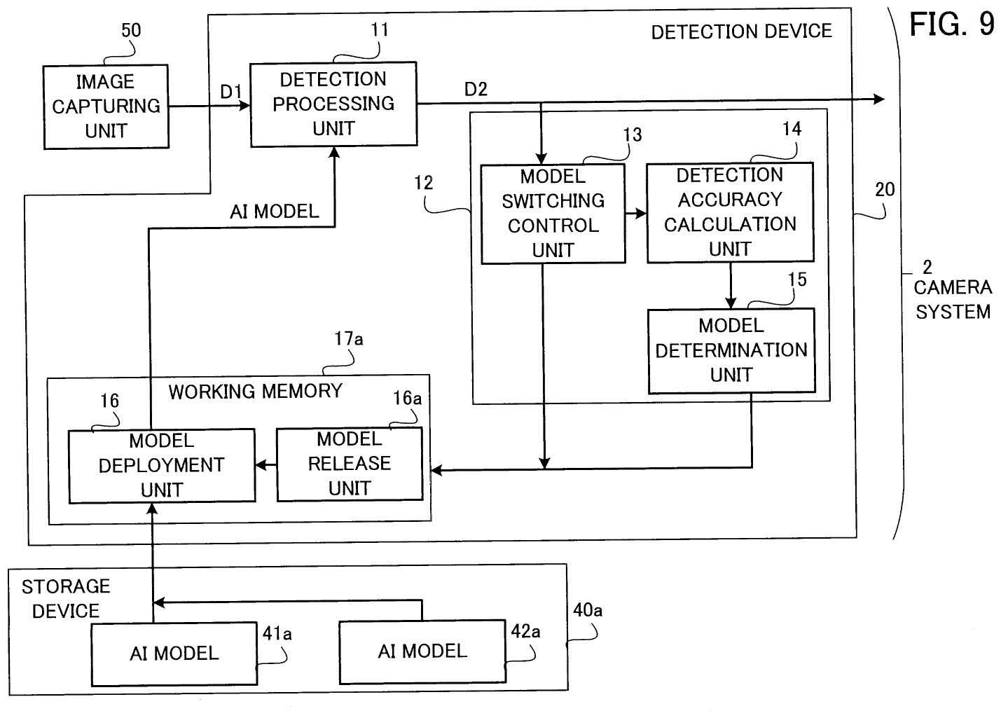

FIG. 9 is a block diagram schematically showing the configuration of a detection device 20 and a camera system 2 according to a second embodiment. The detection device 20 is a device capable of executing a detection method according to the second embodiment. In FIG. 9, each component identical or corresponding to a component shown in FIG. 1 is assigned the same reference character as in FIG. 1. The detection device 20 according to the second embodiment differs from the detection device 10 according to the first embodiment in the configuration of the model deployment unit 16 and in including a model release unit 16a that releases the AI models deployed in a working memory 17a.

In the first embodiment, a description is given of the configuration in which all of the plurality of AI models 41, 42 and 43 stored in the storage device 40 can be deployed in the working memory 17a as shown in FIG. 5. Incidentally, the memory deployment from the storage device 40 generally takes a considerable time. Further, depending on the capacity size of an AI model, there is a possibility that the entirety of a usable AI model cannot be deployed due to exhaustion of the capacity of the working memory 17a.

Thus, in the second embodiment, a description will be given of a process when only part of the plurality of AI models 41, 42 and 43 stored in the storage device 40 can be deployed due to restriction on the processing time, hardware resources, or the like.

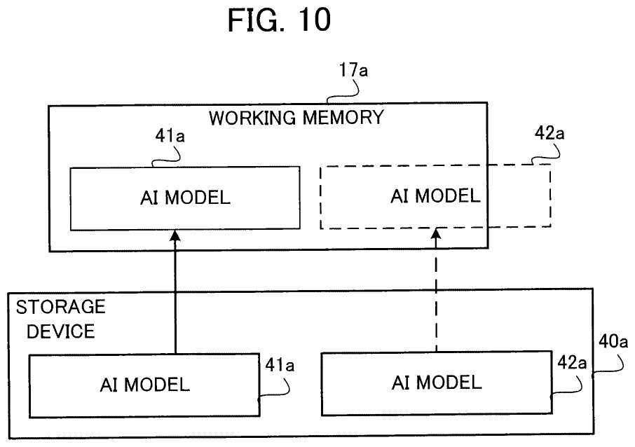

FIG. 10 is an explanatory diagram showing the operation when AI models are deployed in the working memory 17a of the detection device 20 according to the second embodiment. FIG. 10 shows a process when the capacity of an AI model 41a is large and only part of usable AI models can be deployed in the working memory 17a. In order to switch the AI model to be used by the detection processing unit 11, it is necessary to release the AI model deployed in the working memory 17a after the process by the detection processing unit 11 is finished and deploy another AI model stored in the storage device 40 in the working memory 17a.

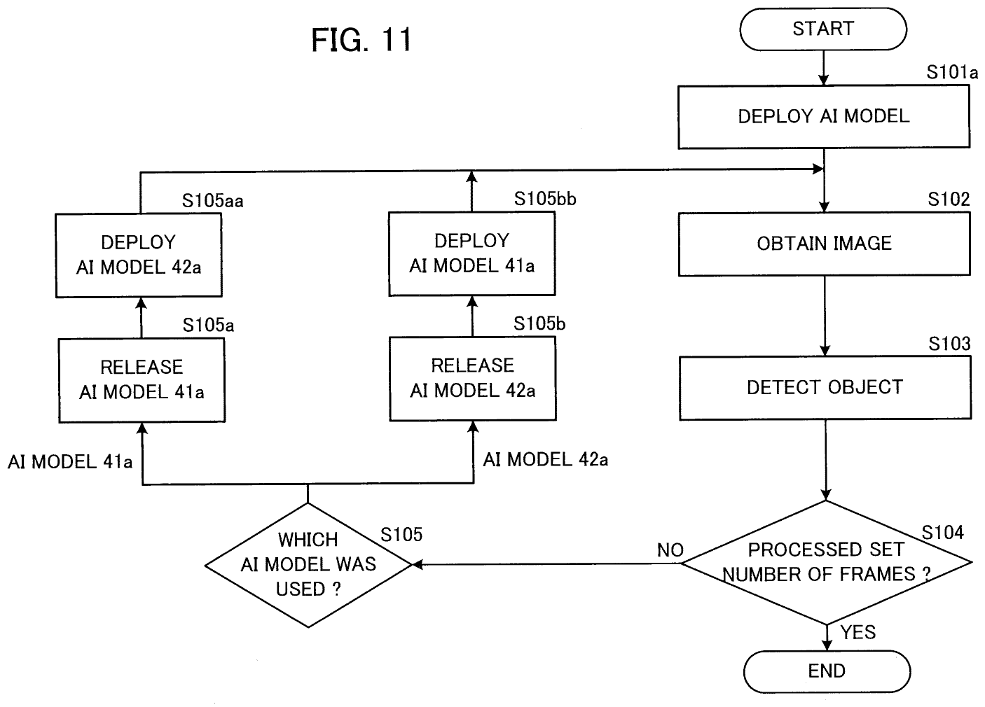

FIG. 11 is a flowchart showing a process for determining the recommended AI model to be used by the detection processing unit 11 of the detection device 20 according to the second embodiment. By using FIG. 11, a description will be given of the flow of the AI model switching in a case where only one of the plurality of AI models 41a and 42a stored in the storage device 40 can be deployed in the working memory 17a.

The model deployment unit 16 deploys the AI model 41a in the working memory 17a (step S101a). The image capturing unit 50 captures an image (step S102).

The detection processing unit 11 executes the object detection process by using the AI model deployed in the working memory 17a by the model deployment unit 16. In this example, the detection processing unit 11 executes the object detection process in the first frame by using the AI model 41a (step S103).

The model switching control unit 13 judges whether or not the object detection process in a predetermined frame number (i.e., set number) m3 of frames has been finished (step S104).

When the model switching control unit 13 judges that the object detection process in the frame number m3 of frames has not been finished, the model switching control unit 13 checks which AI model is the AI model used by the detection processing unit 11 (step S105).

If the AI model 41a is used, the model release unit 16a releases the AI model 41a from the working memory 17a (step S105a). The model deployment unit 16 deploys the AI model 42a from the storage device 40 into the working memory 17a (step S105aa).

If the AI model 42a is used in the step S105, the model release unit 16a releases the AI model 42a from the working memory 17a (step S105b). The model deployment unit 16 deploys the AI model 41a from the storage device 40 into the working memory (step S105bb).

While the description in the second embodiment has been given of the configuration in which only one AI model out of the plurality of AI models stored in the storage device 40 can be deployed in the working memory 17a, it is permissible even if two or more AI models are deployed.

As described above, according to the second embodiment, even when only part of the plurality of usable AI models can be deployed in the working memory 17a, that is, even when a large AI model is used, it is possible to make an AI model with high detection accuracy operate by repeating the deploying of AI models for an amount that can be deployed in the working memory 17a and the releasing of a deployed AI model after the process is finished, Further, in this case, it is possible to make the detection device 10 operate while switching the AI memory deployed in the working memory 17a to one of the plurality of AI models.

Except for the above-described features, the second embodiment is the same as the first embodiment.

### Third Embodiment

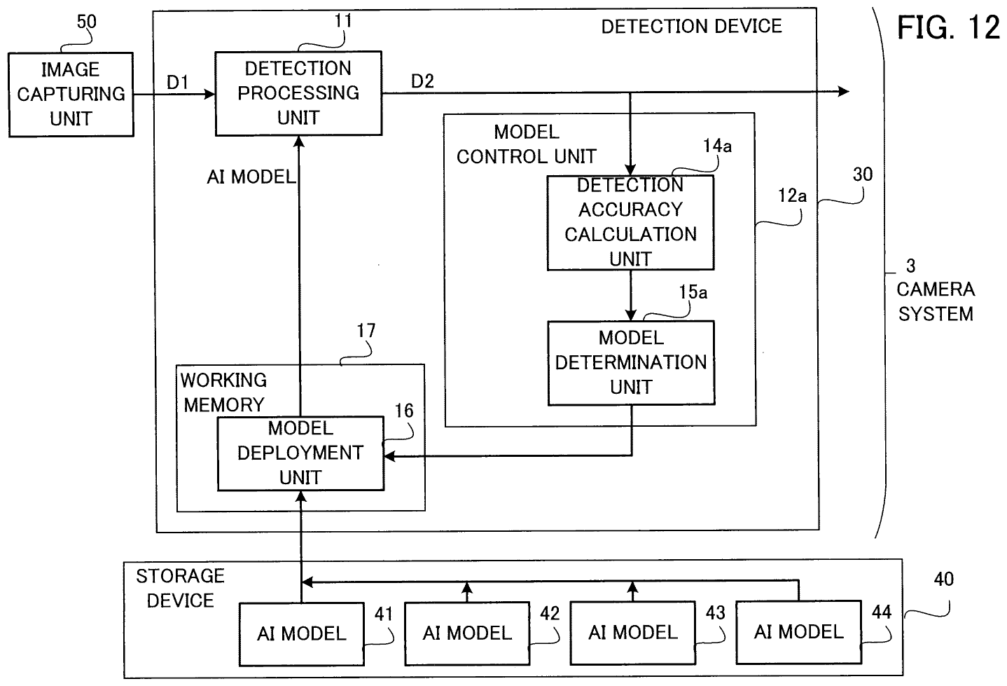

FIG. 12 is a block diagram schematically showing the configuration of a detection device 30 and a camera system 3 according to a third embodiment. The detection device 30 is a device capable of executing a detection method according to the third embodiment. In FIG. 12, each component identical or corresponding to a component shown in FIG. 1 is assigned the same reference character as in FIG. 1. The detection device 30 according to the third embodiment differs from the detection device 10 according to the first embodiment in the configuration and the operation of a model control unit 12a. Specifically, in the detection device 30 according to the third embodiment, the number of frames processed by the model control unit 12a can be determined not by previously determining the frame number m1 but by execution of a process by a detection accuracy calculation unit 14a and a model determination unit 15a.

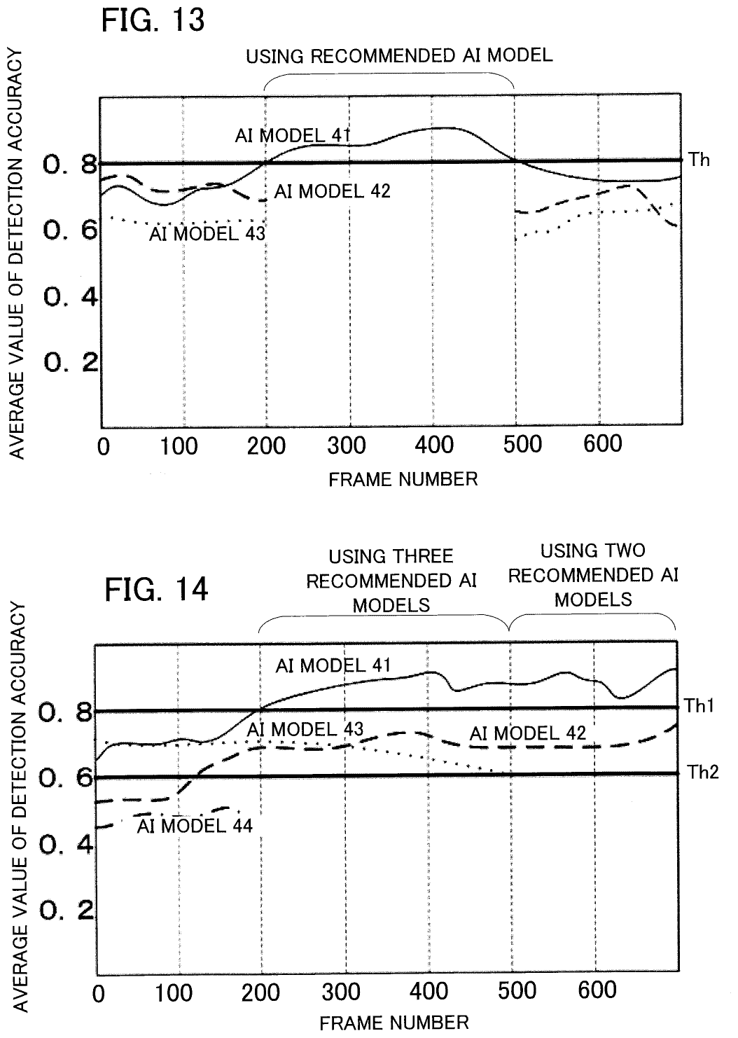

FIG. 13 is a diagram showing an example of a process for determining the recommended AI model to be used by the detection processing unit 11 of the detection device 30 according to the third embodiment. FIG. 13 indicates variations in the detection accuracy average values Av of the three AI models 41, 42 and 43 by using a solid line, a broken line and a dotted line.

First, the model control unit 12a sets a threshold value Th regarding the detection accuracy. Here, the threshold value Th is tentatively set at “0.8”. In the 0th frame to the 200th frame as a period in which the detection accuracy average values Av of all of the usable AI models are below the threshold value Th, the model control unit 12a switches among the three AI models each frame and the detection accuracy calculation unit 14a calculates the detection accuracy average values Av.

In approximately the 200th frame (e.g., at a time slightly before the 200th frame), the detection accuracy average value Av of the AI model 41 (solid line in FIG. 13) exceeded the threshold value Th, and thus, the model determination unit 15a determines the AI model 41 as the recommended AI model to be used by the detection processing unit 11 in the frame and later. As described here, the criterion for determining the recommended AI model to be used by the detection processing unit 11 is whether the detection accuracy average value Av has exceeded the threshold value Th or not, and is not the frame number previously determined.

Also in the 200th frame and later, the detection accuracy calculation unit 14a calculates the detection accuracy average value Av, and whether the average value Av has fallen below the threshold value Th or not is judged each frame.

In approximately the 500th frame in which the detection accuracy average value Av of the AI model 41 (solid line in FIG. 13) falls below the threshold value Th, the model control unit 12a outputs the detection accuracy average values Av while switching among the three AI models. As described here, the criterion for determining up to which time point the recommended AI model (the solid line, the broken line or the dotted line in FIG. 13) should be used by the detection processing unit 11 is whether the detection accuracy average value Av has fallen below the threshold value Th or not, and is not the frame number previously designated.

While the example of determining one AI model as the recommended AI model out of three AI models has been described above with reference to FIG. 13, it is also possible to determine two or more AI models as the recommended AI models out of two or more AI models.

For example, the model control unit 12 calculates the accuracy in regard to each of a plurality of learned models, has a predetermined first threshold value Th1 and a predetermined second threshold value Th2 lower than the first threshold value Th1; calculates the accuracy in regard to each of a plurality of learned models, and when there occurs a learned model having the accuracy exceeding the first threshold value Th1, determines one or more learned models having the accuracy exceeding the second threshold value Th2 as recommended learned models.

FIG. 14 is a diagram showing another example of the process for determining the recommended AI model to be used by the detection processing unit 11 of the detection device 30 according to the third embodiment. FIG. 14 indicates variations in the detection accuracy average values Av of four AI models 41, 42, 43 and 44 by using a solid line, a broken line, a dotted line and a chain line. FIG. 14 shows an example of determining three AI models out of the four AI models 41 to 44. When it is desired to determine a plurality of AI models, a threshold value (hereinafter referred to as the “second threshold value Th2”) having a value lower than a threshold value (hereinafter referred to as the “first threshold value Th1”) is previously set.

In approximately the 200th frame in which the AI model 41 which has the highest detection accuracy exceeds the first threshold value Th1, the model control unit 12a judges whether or not the remaining three AI models exceeds the second threshold value Th2.

In FIG. 14, two AI models 42 and 43 have exceeded the second threshold value Th2, and thus these two AI models 42 and 43 are also made to operate in the detection processing unit 11 while switching among the AI models. Further, as shown in the 500th frame and later, the AI model 43 that has fallen below the second threshold value Th2 may be stopped from operating in the detection processing unit 11 and the AI models 41 and 42 exceeding the second threshold value Th2 may be made to operate as before.

Incidentally, suppose that the AI models 42, 43 and 44 have exceeded the second threshold value Th2 in the 200th frame, it is possible to make all of the usable AI models operate. For example, it is possible to allow for modification of AI model operation rules with reference to the two threshold values depending on the hardware resources or the presence/absence of a margin of the processing load, such as using AI models up to four AI models if the AI model 41 exceeds the first threshold value Th1 and using AI models up to four AI models if the AI model 41 does not exceed the first threshold value Th1 depending on the detection accuracy value of the AI model having the highest detection accuracy (assumed to be the AI model 41).

As described above, in the third embodiment, when the detection accuracy has dropped, the use of the AI model is stopped immediately and the AI model being used is switched to another AI model, by which the detection accuracy can be maintained higher compared to the case where the frame number is previously designated.

Further, in the third embodiment, by setting a plurality of AI models as the recommended AI models to be used by the detection processing unit, a plurality of AI models having high detection accuracy can be made to operate.

Except for the above-described features, the third embodiment is the same as the first or second embodiment.

### DESCRIPTION OF REFERENCE CHARACTERS

1-3: camera system, 10, 20, 30: detection device, 50: image capturing unit, 11: detection processing unit, 12: model control unit, 13, 13a: model switching control unit, 14, 14a: detection accuracy calculation unit, 15, 15a: model determination unit, 16: model deployment unit, 16a: model release unit, 17, 17a: working memory, 40: storage device, 41, 42, 43, 44, 41a, 42a: AI model (leaned model), 121, 124: input, 122: person detection AI model, 123: output, 123a: person detection result (object detection result), 123b: detection frame, 125: face detection AI model, 126: output, 126a: face detection result (object detection result), 126b: output.

1. A detection device comprising:
processing circuitry
to execute a detection process of using a learned model selected from a plurality of learned models, using an image as an input to the selected learned model, and obtaining a detection result, as a result of detecting an object in the image, as an output from the selected learned model; and
to execute a determination process of having the detection process executed in regard to each of the plurality of learned models, calculating accuracy of the detection result in regard to each of the plurality of learned models, and determining a recommended learned model out of the plurality of learned models based on the accuracy,
wherein the detection process after the determination process is executed by using the recommended learned model.

2. The detection device according to claim 1, wherein the processing circuitry
executes the detection process and outputs the detection result in regard to each frame in the image, and
calculates the accuracy in regard to each of the plurality of learned models and in regard to each frame.

3. The detection device according to claim 2, wherein the processing circuitry calculates a statistical value of the accuracy in regard to each of the plurality of learned models and determines the recommended learned model out of the plurality of learned models based on the statistical value.

4. The detection device according to claim 3, wherein the model control unit determines a learned model having the highest statistical value among the plurality of learned models as the recommended learned model.

5. The detection device according to claim 2, wherein the model control unit executes a determination process of calculating the accuracy of the detection result in regard to each of the plurality of learned models after the detection process is executed for a predetermined first frame number of frames and determining the recommended learned model out of the plurality of learned models based on the accuracy.

6. The detection device according to claim 5, wherein the processing circuitry executes the determination process of calculating the accuracy of the detection result and determining the recommended learned model based on the accuracy again after the detection process using the recommended learned model is executed for a predetermined second frame number of frames.

7. The detection device according to claim 2, wherein the processing circuitry calculates the accuracy in regard to each of the plurality of learned models and determines a learned model having the accuracy exceeding a predetermined threshold value as the recommended learned model.

8. The detection device according to claim 2, wherein the processing circuitry
has a predetermined first threshold value and a predetermined second threshold value lower than the first threshold value,
calculates the accuracy in regard to each of the plurality of learned models, and
when there occurs a learned model having the accuracy exceeding the first threshold value, determines one or more learned models having the accuracy exceeding the second threshold value as the recommended learned models.

9. The detection device according to claim 1, further comprising a working memory in which one or more learned models out of the plurality of learned models are deployed,
wherein the processing circuitry executes the detection process by using a learned model deployed in the working memory.

10. The detection device according to claim 9, wherein the processing circuitry
releases a storage area by deleting the learned model deployed in the working memory; and
deploys one of the plurality of learned models in the working memory having the released storage area.

11. A camera system comprising:
the detection device according to claim 1; and
a camera to capture the image.

12. A detection method to be executed by a detection device, comprising:
executing a detection process of using a learned model selected from a plurality of learned models, using an image as an input to the selected learned model, and obtaining a detection result, as a result of detecting an object in the image, as an output from the selected learned model;
executing a determination process of having the detection process executed in regard to each of the plurality of learned models, calculating accuracy of the detection result in regard to each of the plurality of learned models, and determining a recommended learned model out of the plurality of learned models based on the accuracy; and
executing the detection process after the determination process by using the recommended learned model.

13. A non-transitory computer-readable record medium storing a record medium storing a detection program that causes a computer to execute:
executing a detection process of using a learned model selected from a plurality of learned models, using an image as an input to the selected learned model, and obtaining a detection result, as a result of detecting an object in the image, as an output from the selected learned model;
executing a determination process of having the detection process executed in regard to each of the plurality of learned models, calculating accuracy of the detection result in regard to each of the plurality of learned models, and determining a recommended learned model out of the plurality of learned models based on the accuracy; and
executing the detection process after the determination process by using the recommended learned model.
